(19) United States
(12) Patent Application Publication
(10) Pub. No.: US 2018/0021627 A1
(43) Pub. Date: Jan. 25, 2018

(54) Interactive and Dynamic Fitness System

(71) Applicant: Strive VR, LLC, Boise, ID (US)

(72) Inventors: Ryan DeLuca, Boise, ID (US); Preston Lewis, Boise, ID (US); Duane Mathes, Boise, ID (US); Daniel Thurber, Boise, ID (US)

(21) Appl. No.: 15/618,608

(22) Filed: Jun. 9, 2017

Related U.S. Application Data
(60) Provisional application No. 62/364,802, filed on Jul. 20, 2016.

(51) Int. Cl. A63B 24/00; A63B 21/00; A63B 22/00; A63B 22/02; A63B 22/06; A63B 22/04; A63B 23/12; A63B 23/04; A63B 22/20; A63B 5/20; A63B 5/16; A63B 71/06; A63F 13/211; A63F 13/24; A63F 13/235; A63B 21/072

(52) U.S. Cl. CPC A63B 24/0021; A63B 21/072; A63B 21/154; A63B 22/0076; A63B 22/02; A63B 22/0605; A63B 22/0664; A63B 22/0087; A63B 22/04; A63B 23/1218; A63B 23/0405; A63B 22/20; A63B 5/20; A63B 5/16; A63B 21/4037; A63B 21/4035; A63B 24/0075; A63B 71/0622; A63B 24/0087; A63F 13/211; A63F 13/24; A63F 13/235; A63B 2023/0411; A63B 2024/0025; A63B 2225/50; A63B 2071/063; A63B 2071/0663; A63B 2071/0661

(57) ABSTRACT

A fitness system includes a training area with exercise equipment and a positional tracking system to record and evaluate a participant. It optionally includes a virtual, augmented, or mixed reality headset, standalone display, computer, additional feedback sensors, accessories, and communication components. The positional tracking system preferably includes one or more laser-based base stations and a plurality of positional tracking sensors placed on or near the participant and equipment. The participant can play games, interact with others, and track performance, and the system dynamically adapts in response to information provided by the tracking system, user inputs, and other sensors or inputs.

### CROSS-REFERENCE TO RELATED APPLICATIONS

This application claims the benefit of co-pending provisional U.S. Application 62/364,802 filed Jul. 20, 2016.

### FIELD OF INVENTION

This invention relates to fitness systems and methods for providing interactive and dynamic fitness or gaming programs. More particularly, this invention relates to a fitness or gaming environment incorporating virtual, augmented, or mixed reality, tracking systems, and dynamically-controlled exercise equipment to improve a participant's fitness performance and overall enjoyment.

### BACKGROUND

Fitness enthusiasts, athletes, bodybuilders, firefighters, servicemen, servicewomen, dancers, physical therapy patients, and many others find themselves working out at home or at gyms and using a variety of equipment. They may follow an individualized plan developed by professional trainers or therapists, may be working as part of a team or with a partner, or may be following some general advice mined from a book or online resource. Often, they are practicing strength training or resistance training, and often they reach a plateau. Some become bored, others stop improving, and yet others become frustrated or confused.

In an attempt to end the daily struggle that millions of people go through to get the exercise that they need to achieve the body and health that they desire, current approaches such as providing a personal coach, offering a variety of classes, and setting up competitions among participants are helpful but not enough. Typically, these approaches provide only a short-term solution; a new method or system of training is needed.

Additional issues also arise with current systems of training due to limitations of conventional exercise equipment. Exercise equipment generally is a one-size-fits-all or only can be modified by changing tension or weight components before beginning an exercise. For some fitness enthusiasts, the equipment can be intimidating or confusing. Additionally, many misuse the equipment due to inexperience or because they misjudge what settings or weights are appropriate. For other fitness enthusiasts and especially for elite athletes, the equipment limits progress because it fails to dynamically adjust as a participant progresses through a movement or limits the participant's ability to customize an exercise to maximize results. A new fitness system is needed to improve the results for all fitness levels.

Accordingly, it would be desirable to provide a new system that dynamically adapts during exercise both as biomechanical leverage changes and according to participant-specific instructions or conditions. Additionally, it would be desirable to provide a new system that addresses boredom by providing interactive and game features and that addresses plateaus by providing personalized motivation, tracking, and fitness coaching and evaluation. It also would be desirable to provide a fitness or gaming environment that can track historical progress and evaluate a participant's form in real time, provide immediate feedback, and automatically adjust exercise equipment as needed.

### SUMMARY OF THE INVENTION

A fitness system for improving and enhancing a fitness or gaming environment includes a dedicated training area with exercise equipment such as constant, variable, and accommodating resistance devices, an optional virtual, augmented, or mixed reality headset, an optional standalone display, a computer, a positional tracking system, optionally additional feedback sensing systems, optional accessories, and wired or wireless communication components incorporated among the exercise equipment, accessories, headset, display, computer, tracking system components, and any other system components featuring tracking sensors or other features requiring communication. The positional tracking system preferably includes positional tracking base stations and a plurality of positional tracking sensors placed on the exercise equipment, headset, and accessories. The fitness system optionally further comprises one or more additional input devices such as microphones, pressure sensors, or game controller components and one or more output devices such as fans, lights, and speakers.

To use fitness system, a participant, optionally wearing one or more accessories and/or headset, enters the dedicated training area to access the exercise equipment, optionally selects any desired fitness or gaming programs, any desired fitness or gaming environment parameters, and whether to participate in virtual reality, augmented reality, mixed reality, or other programming. When selected, virtual reality, augmented reality, or mixed reality programming or other programming may be delivered on the display or on the headset's display. Likewise, the equipment is positioned, calibrated, and initialized according to the selected fitness program, and the environment is created according to the environment parameters selected. The positional tracking system activates, and the position of the equipment and the participant are tracked, recorded, and evaluated. Additional information also is gathered through any other sensors or inputs (e.g., pressure sensors in the floor or wall) where appropriate. Based on the position of the equipment and participant and based on any additional sensed or received information, virtual reality content, additional programming, the equipment, and the environment can all be adjusted. In particular, the exercise equipment can dynamically-adjust its position and behavior as needed depending on the information received about the participant and the equipment to change, for example, the resistance, speed, or intensity. A participant who enjoys three 30-minute fitness sessions a week should increase his strength, endurance, and health and achieve his desired body composition and shape, all while enjoying his fitness sessions.

### BRIEF DESCRIPTION OF THE DRAWINGS

FIG. 1 is a block diagram of the present invention.

FIG. 2 is a perspective view of one embodiment of an electronically controlled resistance exercise machine of the present invention.

FIG. 2A is a block diagram of the resistance units of the embodiment of the electronically controlled resistance exercise machine shown in FIG. 2.

FIG. 3 is a perspective view of an embodiment of an alternative electronically controlled resistance exercise machine of the present invention.

FIG. 4 is a front view of a handle of the present invention.

FIG. 5 is a diagram of accessories useful with the present invention.

FIG. 6A is a top view of an embodiment of a wearable accessory useful with the present invention.

FIG. 6B is a side view of the wearable accessory shown in FIG. 6A.

FIG. 6C is an end view of the wearable accessory shown in FIGS. 6A and 6B.

FIG. 7 is a diagram of a preferred positional tracking system of the present invention.

FIG. 8 is a flowchart detailing a method of use of the present invention.

### DETAILED DESCRIPTION OF THE INVENTION

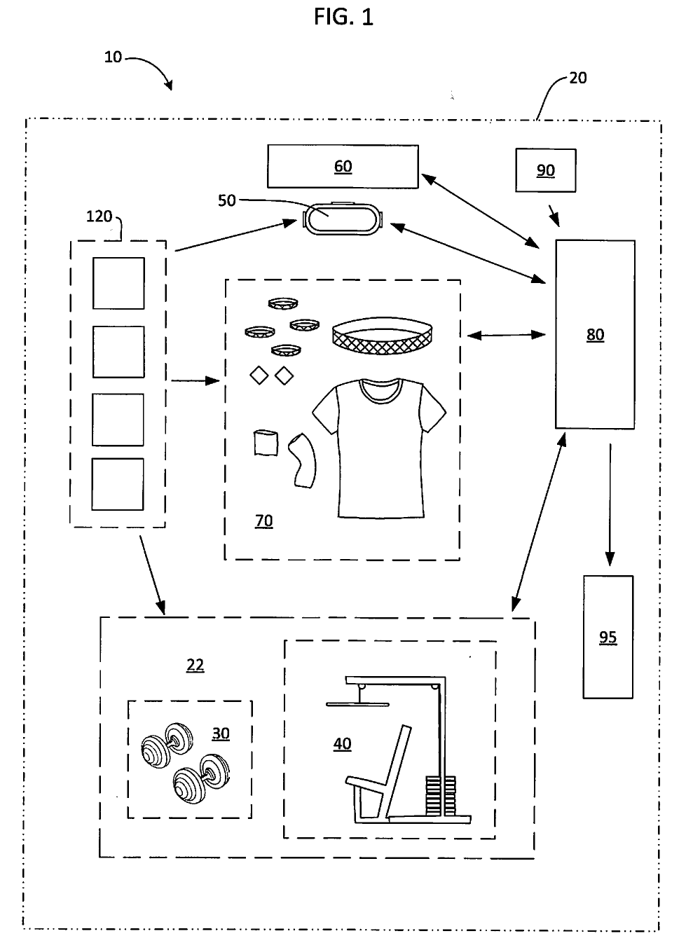

A fitness system 10 for improving and enhancing a fitness or gaming environment is shown in FIGS. 1-7. Fitness system 10 includes a dedicated training area 20 with exercise equipment such as constant resistance devices 30 and variable or accommodating resistance devices 40, an optional virtual, augmented, or mixed reality headset 50, an optional standalone display 60, one or more optional accessories 70, a computer 80, a tracking system 100, and wired or wireless sensor communication components 140 or equipment communication components 142 incorporated among the exercise equipment, accessories, headset, display, computer, tracking system components, and any other system 10 components featuring sensors or other features requiring communication. Fitness system 10 optionally further comprises one or more additional input devices 90 such as microphones, pressure sensors, or game controller components 930 and one or more output devices 95 such as fans, lights, and speakers. Positional tracking system 100 preferably comprises an outside-in tracking system such as one that includes at least one or more base stations 120 and a plurality of positional tracking sensors 130 placed on the exercise equipment, accessories, and headset. Alternatively, positional tracking system 100 comprises an inside-out tracking system such as one where the positional tracking sensors 130 are placed on stationary objects and cameras are placed on movable objects such as the headset or exercise equipment and accessories.

The dedicated training area 20 is any fitness or gaming environment that can house necessary components for fitness system 10. Preferably, dedicated training area 20 is a dedicated room or defined section of a room. Also preferably, dedicated training area 20 comprises walls or other structures sufficient to support traditional wall-mounted exercise equipment, positional tracking components, displays, and the like. Also preferably, dedicated training area 20 comprises a floor sufficient for supporting exercise equipment, participants and trainers, and other objects traditionally supported by a foundational structure. Dedicated training area 20 may also include features such as an exercise pool or raised platforms that further make or fall within its boundaries. It is anticipated that the system and method described herein can be adapted to many training or gaming environments such as, for example, gyms, arcades, personal training studios, dance centers, schools, hospitals, and rehabilitation centers. Further, it is anticipated that they system and method described herein will be useful with many types of fitness activities, physical training, rehabilitation, and other gaming activities. Additionally, while the system is described as a fitness system throughout, it is intended that fitness systems include all kinds of fitness, health-related, gaming, and recreational systems that include similar structures and methods of operation.

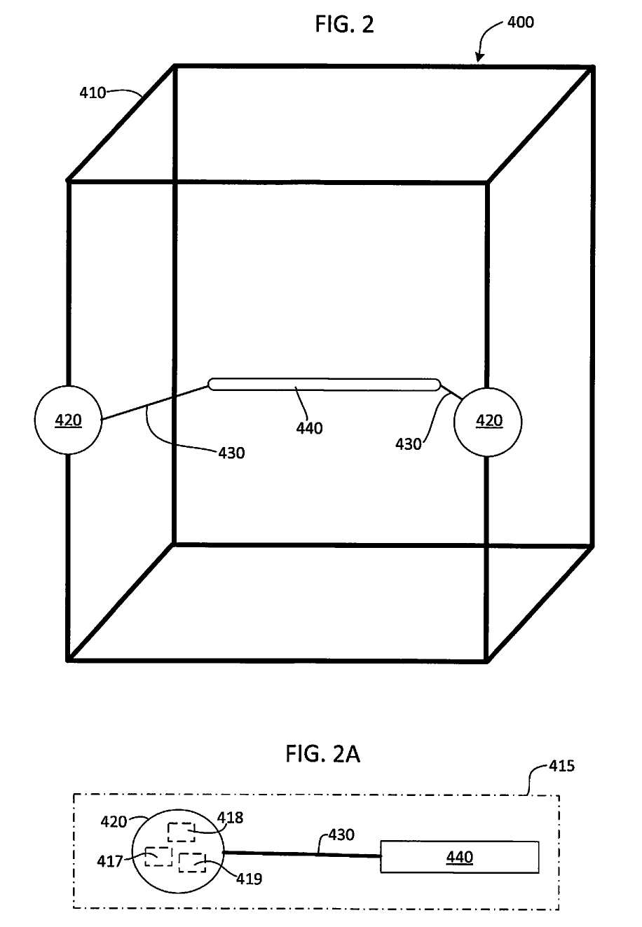

Located within dedicated training area 20 are one or more exercise equipment, apparatuses, or machines 22, which includes all types of machines, devices, apparatuses, and structures useful for fitness, health, training, recreational, and gaming applications and activities. Many types of exercise equipment 22 include at least one moveable component such as a handle 440 as shown in FIG. 2 or the entire free weight 30 as shown in FIG. 1. Exercise apparatuses or machines 22 can be any type of exercise or gaming equipment traditionally found in gyms, health clubs, fitness centers, outdoor trails, arcades, or other fitness environments. For example, exercise machines or apparatuses 22 include equipment such as stairs, platforms, balance balls, ropes, bars, ladders, medicine balls, tires, pull-up rings, bumper plates, stands, kettlebells, jump ropes, plyometric boxes, dumbbells, mats, bands, glute-ham developers (GHDs), parallettes, squat stands, smith machines, weights, weight racks, stackable steps, abdominal trainers, rollers, stability balls, wall balls, dipping bars, yoga straps and silks, blocks, suspension straps, tubing, physioballs, pulleys, bungees, cables, bolsters, wedges, tables, and the like. Exercise apparatuses or machines 22 also include equipment such as rowers or ergometers, bicycles, treadmills, elliptical machines, ski machines, reformers, arc trainers, vibration platform machines, steppers, climbing machines, adaptive motion trainers, hand ergometers, airdyne bicycles, recumbent bicycles, spin bicycles, stationary bicycles, jacobs ladders, ski ergometers, resistance devices, and the like.

In addition to the standard features for the exercise equipment, which will be known by those skilled in the art, the exercise equipment 22 may, where appropriate, include exercise equipment communication components 142 to facilitate wired or wireless communication with other parts or components of the fitness system 10. Additionally, where the exercise equipment includes controllable moving parts, the exercise equipment may also include equipment control and processing components 144 and electrical, mechanical, or electromechanical components as necessary to facilitate communication with other devices and to facilitate receiving, processing, and executing instructions necessary to move or operate the equipment or its parts. An example of equipment control and processing components and electrical, mechanical, or electromechanical components is further discussed below and shown in FIG. 2A with respect to resistance devices in particular. The exercise equipment may also include modified smart handles 900 to further facilitate cooperating with other parts or components of fitness system 10 and to improve the participant's control over features of the equipment 22 and system 10 and to enhance the participant's enjoyment of the fitness system 10 in general.

Preferably, dedicated training area 20 includes at least one exercise device or machine 22 that facilitates resistance training such as constant resistance devices 30 or variable or accommodating resistance devices 40. Other types of resistance devices may also or alternatively be present including static resistance devices for isometric exercises. Constant resistant devices 30 are devices such as free weights where the resistance does not substantially change. Variable resistance and accommodating resistance devices 40 include devices such as offset cam machines that change resistance through the participant's range of motion as well as spring loaded and resistance band machines. They also include machines that limit ballistic movement by controlling the speed at which the machine moves such that a participant exerts his maximum resistance throughout the full range of movement. Machines useful with the present invention may include various mechanical, electrical, electromechanical, and other components including, for example, pneumatics, linear actuators, servo motors and drives, payout winches, and magneto-rheological dampers as well as materials such as graphene and metamaterials.

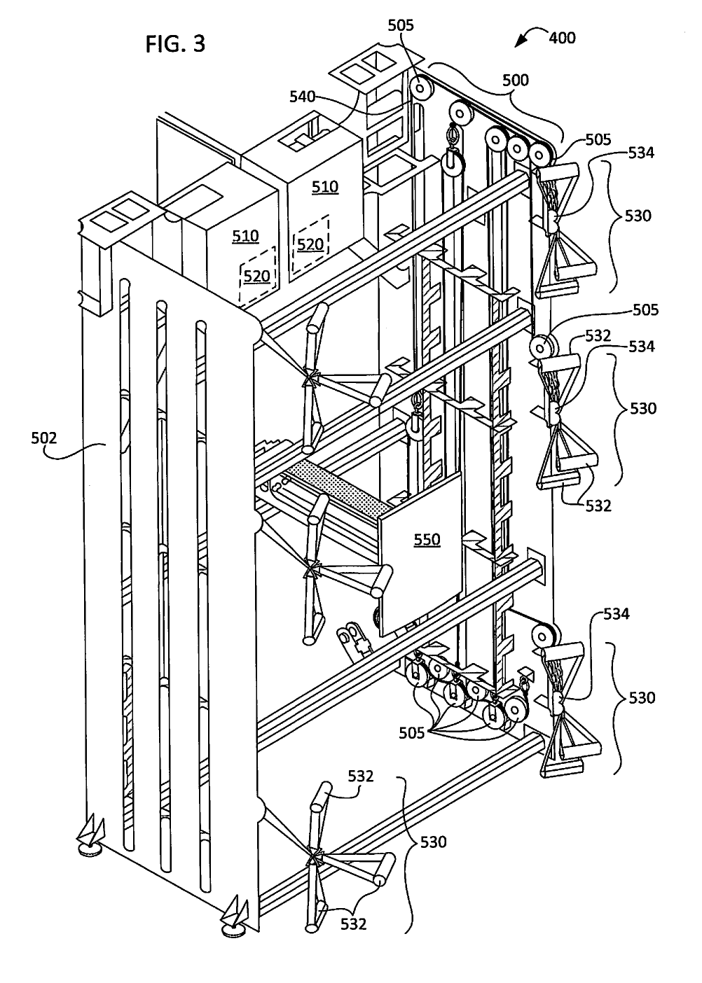

A preferred variable or accommodating resistance device 40 useful for the present invention is an electronically-controlled cable system 400, such as the ones shown in FIGS. 2 and 3. The cable system 400 in one embodiment and as shown in FIG. 2 may comprise one or more fixed-location resistance units or one or more resistance units 415 that are repositionable. The cable system 400 optionally and preferably includes resistance units 415 that can vary the resistance, speed, or intensity of the exercise for the participant. More preferably, the cable system 400 includes at least one resistance unit 415 that can reposition itself around the dedicated training area 20 according to instructions provided by the participant, the resistance unit itself, other resistance units, the cable system, or cooperating components of fitness system 10. Preferably each resistance unit includes equipment wireless communication components 417, equipment control and processing components 418, and electric, mechanical, or electromechanical components 419 as necessary to facilitate communication with other devices and to facilitate receiving, processing, and executing instructions necessary to move or operate the resistance unit and its various components.

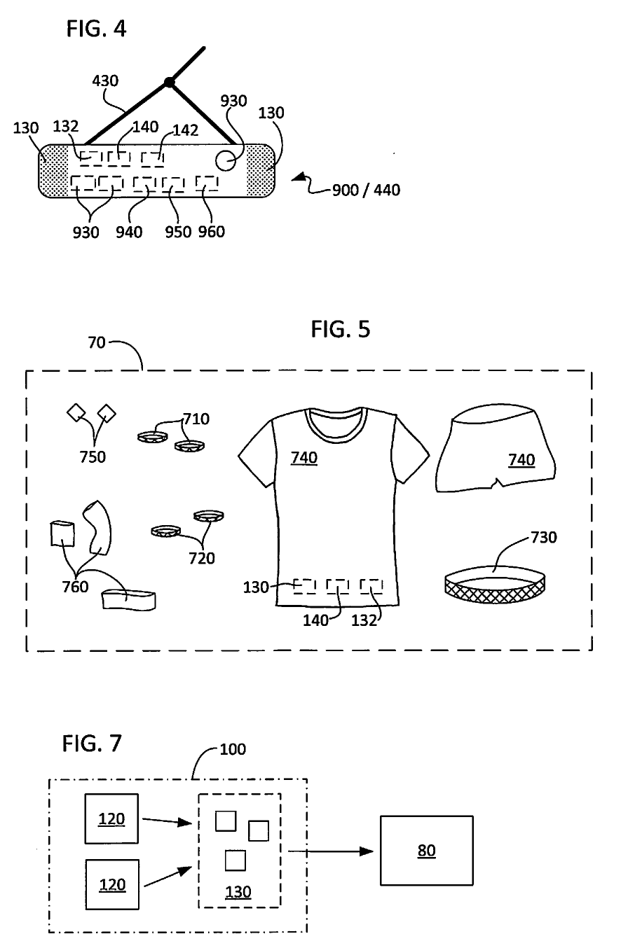

The resistance units 415 of cable system 400 preferably are supported by a framework 410 along which they can travel vertically and horizontally and includes one or more cable housings 420 to house the communication components 417, control and processing components 418, and other components 419. Additionally, resistance units 415 further include cables 430 that cooperate with or attached to components in cable housing 420. For example, cables 430 may be attached to a winch housed in cable housing 420. Cables 430 may also be attached to independent or shared handles 440 such as the shared handle shown in FIG. 2 or the independent handles shown in FIG. 4. Alternatively, cable system 400 may comprise multiple frameworks 410, or the framework may be replaced by other systems capable of translating a housing in two or three dimensions.

In a preferred embodiment and as shown in FIG. 3, cable system 400 is a framework or cage 502 that supports and houses one or multiple pulley systems 500. Pulley systems 500 preferably cooperate with one or more electric motors 510 housed in or secured to cage 502 to provide constant or adjustable resistance as needed. The motors 510 are controlled by pulley system control and processing components 520 that process and execute software stored locally or remotely. As shown, the pulley systems 500 include one or more stationary or repositionable pulleys 500 with one or more cables 540 that are cooperate with and preferably are connected to at least one of motors 510. Cables 540 also are optionally attached to one or more handle bundles 530 that each contain one or more individual handles 532. Handles 532 may be simple handles commonly found on exercise equipment or smart handles as described herein. Additionally, handles 532 individually or handle bundles 530 dock in a hinged or stationary handle support 534 that orients the cables 540 attached to handles 532 or bundles 530 and provides a reference position for the tracking system 100 to recognize when the handles are in use or docked. Handle supports 534 may be fixedly or repositionably attached to cage 502. For example, handle supports 534 may manually or automatically translate along a rail or channel along the edge of cage 502 to a desired position where they then manually or automatically lock in place. Cable system 400 may also include supports for the person using the system and for additional components. For example, as shown in FIG. 3, systems 400 optionally includes a retractable bench pad 550 against which a person can support himself while using the system.

For some of the resistance devices, exercise machines, or exercise apparatuses of fitness system 10, one or more of handles or handheld components optionally are smart handles 900 that optionally include one or more of the following: control and processing components 960 to receive, process, and execute commands as necessary, feedback components 940, tracking sensors 950, and one or more game controller components 930 as shown in FIG. 4. Smart handles 900 include the resistance unit handle 440, and smart handles 900 and 440 may be identical or include identical features. Accordingly, references to components for smart handles 900 or resistance unit smart handles 440 herein is intended to apply to both handles 900 and 440.

Smart handles 900 and 440 may cooperate with hardware and software on the headset 50, any cooperating computer system 80, the cooperating display 60, the exercise equipment and apparatuses 22, the accessories 70, and the positional tracking system 100. Where smart handles include game controller components 930, the game controller components may include, for example, buttons, accelerometers, gyroscopes, photodiodes, touchpads, heart rate monitors, pressure sensors, photo resistors, IR receivers, IR transmitters, and communication components such as Bluetooth® technology, wireless sensor networks, advanced network tools (ANT+), wireless home digital interface technology (WHDI), or other local area wireless technologies such as Wi-Fi. In particular, the game controller components 930 may cooperate with hardware and software on headset 50 or may cooperate with other game engines on the computer system 80, with pneumatics, linear actuators, servo motors and drives, payout winches, and magneto-rheological dampers on the exercise equipment and with other devices and components or materials of other devices including graphene and metamaterials. Smart handles 900 and 440 may further incorporate any other features commonly found in game controllers.

Many of the resistance devices and exercise equipment and apparatuses of fitness system 10 further include a plurality of positional tracking sensors 130 and optional other feedback sensors 132, as shown in FIG. 4. Positional tracking sensors 130 and other sensors 132 shown in FIG. 4 are shown as an example only and include individual sensors, groups of sensors, or sensor units that combine a sensor with communication components, power sources, displays, control and processing components, other computing components, indicators, or some combination thereof. The actual size and number of the sensors will vary according to many factors such as the type of sensor selected, the components of the sensor or sensor unit, the information to be collected, and the size and shape of the object being tracked.

In a preferred embodiment and such as with an outside-in type positional tracking system, positional tracking sensors 130 detect position information 131 including, for example, information such as the sensor's position at any given time. The position information may be stored by the sensor, evaluated by the sensor, or communicated by the sensor to another device capable of receiving and evaluating the sensor. Preferably, positional tracking sensors 130 are photosensors that cooperate with the positional tracking base stations 120 to work together as the positional tracking system 100. Positional tracking sensors 130 also electronically or otherwise communicate with computer system 80 or other components of fitness system 10 via communication components 140 which may be separate from or combined using any communication components available on components of the fitness system 10 such as among the optional game controller components 930 of smart handle 900 or 440 or the equipment communication components 142. Positional tracking sensors 130 are intended to sense information that allows cooperating computer hardware and software to calculate the position of the object on which the sensors 130 are located.

Optional additional feedback sensors 132 may be any type of sensor that provides information about the participant, environment, or apparatus such as tactile sensors, motion sensors, temperature sensors, electric potential sensors, optical sensors, pressure sensors, acoustic sensors, vibration sensors, oxygen sensors, altimeters, gyroscopes, impact sensors, odometers, shock detectors, and biosensors. Feedback sensors 132 detect status information 133 including, for example, information about the object's status or the participant's health at any given time. The status information 133 may be stored by the sensor, evaluated by the sensor, or communicated by the sensor to another device capable of receiving and evaluating the sensor. Feedback sensors 132 also electronically communicate with computer system 80 or other components of fitness system 10 via sensor communication components 140 which may be separate from or combined using any communication components of system 10 such as the equipment communication components 142 or the communication components among the optional game controller components 930.

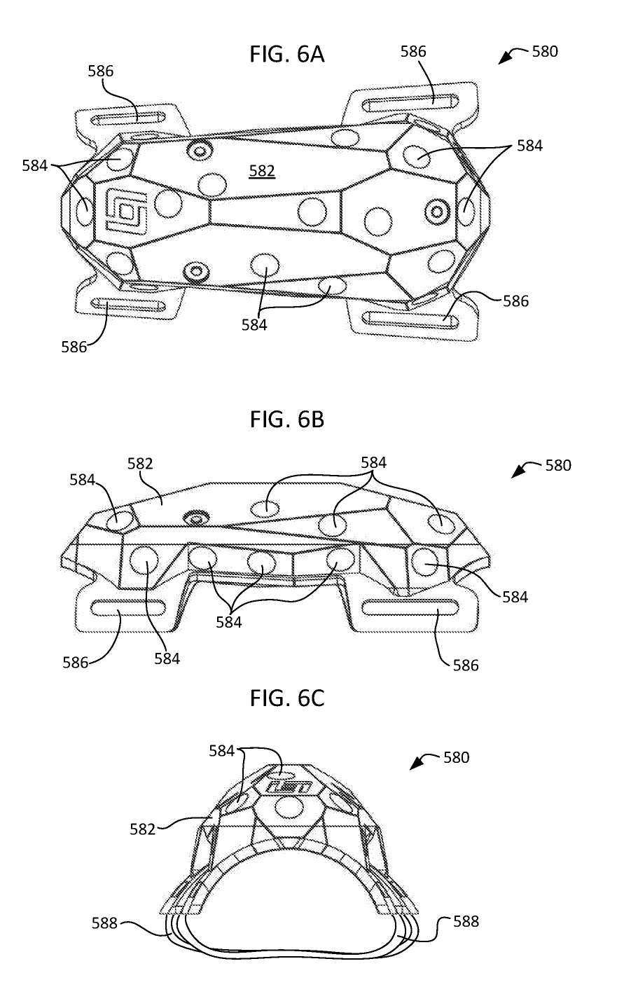

Positional tracking sensors 130 and optional feedback sensors 132 also are placed around the accessories 70 and headset 50 that can be worn by the participant, or they can be attached to additional equipment. FIG. 5 illustrates a few types of accessories 70 useful with the present invention such as bracelets 710, anklets 720, a belt 730, clothing 740, permanent or repositionable markers 750, and wristbands, armbands, knee bands, headbands, or sleeves 760. FIGS. 6A-6C illustrate an additional embodiment of a smart hands or smart feet wearable accessory useful with the present invention. The smart hands/feet wearable accessory is a repositionable location device 580 that includes a housing 582 that accommodates sensors 584 and can be secured to a person's wrists or ankles using straps 588 that attached to the housing. For example, straps 588 may be a continuous elastic material or maybe two or more elastic or non-elastic pieces that secure together with a fastener such as a buckle, snap, or hook and loop closures. Straps 588 may attach to housing 582 at slots 586 defined by housing 582 or by sewing fasteners, adhesives, or other methods of attaching strap material to devices. Housing 582 may be rigid, flexible, or resilient, but preferably is a lightweight rigid material capable of securing multiple sensors 584 on its surface and, where appropriate, within the housing itself. Other components, such as wireless communication components and control and processing components, may also be secured on or in housing 582. Sensors 584 may be positional tracking sensors 130, optional feedback sensors 132, or some other type of sensor. While the location device 580 is shown in FIGS. 6A-6C as configured for use with a person's wrists and ankles, the housing and straps could be modified to work with other body parts or to attach to other items worn by or used by the participant.

For simplicity, sensors 130 and 132 and sensor communication components 140 are only shown in FIG. 5 as present on clothing 740 but also can be included on each of the accessories as desired, can be included in multiple quantities on each accessory as desired, and can be placed anywhere on clothing 740 or other accessories as desired. Any type of accessory capable of supporting a sensor can be modified to include sensors 130, as will be understood by those skilled in the art. As with the positional tracking sensors 130 on the exercise equipment and exercise equipment handles, the positional tracking sensors 130 on the accessories 70 and headset 50 are positional tracking sensors that may vary in their actual size and number according to many factors such as the type of sensor selected, the information to be collected, and the size and shape of the object being tracked. Further, positional tracking sensors 130 may comprise special material or be made of a particular textile that is useful for positional tracking. Preferably, positional tracking sensors 130 are photosensors that cooperate with the positional tracking base stations 120. Optional feedback sensors 132 that are useful on the accessories 70 are described above with respect to their use on exercise equipment and apparatuses. Positional tracking sensors 130 and optional feedback sensors 132 also electronically communicate with computer system 80 or other components of fitness system 10 via sensor communication components 140 that are also preferably included among the accessories 70.

The information collected from positional tracking sensors 130 and feedback sensors 132 on the accessories and on the exercise equipment can be communicated to the computer 80, the headset 50, the display 60, any another fitness system component, or any combination thereof. For example, the information collected by sensors 130 and 132 on one accessory may be communicated to the computer 80 and one of the smart handles 900 or 440. Likewise, information collected by sensors 139 and 132 on smart handle 900 or 440 may be communicated to the display 60 and headset 50. In some cases information collected by sensors 130 and 132 may first be communicated a first component of fitness system 10 and then further communicated from the first component to a second component of fitness system 10.

The information collected by sensors 130 and 132 may be used, for example, to determine whether and by how much to adjust the resistance or other parameter on the exercise equipment, to provide instruction to the participant when the participant should alter his form or technique, to provide information that adjusts virtual, augmented, or mixed reality content being displayed on the headset 50 or display 60, or to log exercise or positional data. For the positional tracking sensors 130, in particular, the information regarding the participant's position before, during, and after an exercise can be determined by information gathered from sensors 130 on accessories worn by the participant, sensors placed on the equipment under control of the participant, and sensors placed directly on the participant. For any additional feedback sensors 132, information regarding the participant's physical response can be monitored such as, for example, the participant's pulse, blood oxygen level, or grip strength before, during, and after an exercise can be determined by information gathered from sensors 132 worn by the participant or held by the participant.

In addition to sensors 130 positioned on and incorporated into the various accessories and the exercise equipment of system 10, additional components necessary to facilitate haptic, tactile, or kinesthetic feedback preferably are also present where it would be desirable to provide such feedback. For example, mechanical, electrical, and electromechanical components 940 may be included in handle 440 of the resistance device 400 shown in FIGS. 2-4 so that handle 440 vibrates when instructed. Similarly, heating elements (not shown) may be embedded in the material used in accessories 70 to cause the accessories 70 to apply heat to the participant when instructed. Additional components known for creating haptic, tactile, and kinesthetic feedback sensations are known to those skilled in the art.

Throughout fitness system 10, various fitness components include wired or wireless communication components, such as sensor communication components 140, equipment communication components 142, resistance unit communication components 417, and game controller components 930. Wireless communication components that are part of the elements of fitness system 10 include any type of component necessary to facilitate wireless communication between each of the system elements such as near field communication components and may also include longer range communication components to facilitate communication with software and content located remotely or accessible only via the Internet. Wired communication components may also be used where practical. Wireless communication components are well known to those skilled in the art and include, for example, Bluetooth® technology, wireless sensor networks, advanced network tools (ANT+), wireless home digital interface technology (WHDI), or other local area wireless technologies such as Wi-Fi. The sensor wireless communication components 140, equipment communication components 142, and other communication components such as those among the game controller components 930 of smart handles 900 or 440 used throughout fitness system 10 preferably allow two-way communication to facilitate collecting information from sensors and delivering instructions back to the accessories or equipment to allow for positional or resistance changes, to allow for haptic feedback, and to allow for content delivery. FIG. 1 illustrates an example of how the various components of fitness system 10 may communicate, as shown by the solid arrows between components.

The preferred outside-in type positional tracking system 100, as shown in FIG. 7, includes a plurality of positional tracking sensors 130 discussed above along with one or more positional tracking system base stations 120 that are preferably laser-based positional tracking components such as Valve Corporation's Lighthouse Base Stations, which use several LEDs to send a synchronization pulse and two laser emitters that spin rapidly to sweep a beam across the dedicated training room. Positional tracking sensors 130 on the headset 50, exercise equipment, and accessories 70 receive and recognize the synchronization pulse and the laser beams. The sensors 130 then communicate the information from base stations 120 along with information specific to each sensor 130 to the computer 80, headset 50, display 60, other components of fitness system 10, or any combination thereof. Using the received information from sensors 130, local or remote programming for the headset 50, display 60, computer system 80, other component of fitness system 10, or any combination thereof can calculate the position of each sensor and thereby determine the position of the participant or any objects housing the sensors 130. Preferably, at least two base stations 120 are positioned cooperatively in dedicated training area 20. Additional base stations 120 may be added to dedicated training area 20, however, to improve accuracy.

In general, for fitness system 10, alternative types of positional tracking systems 100 may also be substituted, but a positional tracking system that allows for six degrees of freedom tracking is ideal. For some aspects of the invention, multiple types of positional tracking systems may work well together. In particular, in addition to the laser-based positional tracking base stations 120 and positional tracking sensors 130, other sensors and components useful for tracking a participant's movement or form also can be used. For example, as shown in FIG. 4, tracking sensors 950 such as accelerometers, gyroscopes, and magnetometers may be incorporated into the resistance devices, headset 50, or accessories 70 to provide additional information to be used by the programming on the headset 50, display 60, or computer system 80. Another positional tracking system appropriate for fitness system 10 is an inside-out tracking system where the position of, for example, the headset, exercise equipment, and/or accessories are determined by evaluating their position relative to stationary positional tracking sensors placed around the dedicated training area. With this type of tracking system, the positional tracking sensors 130 still track the position of the participant or the equipment, but do so based on their static position relative to the movement of the participant or equipment. The location of the positional tracking sensors relative to the participant or equipment can be, for example, evaluated by recognizing the sensors 130 with cameras and optionally with additional motion or location sensors located on the equipment, on the participant, on a headset worn by the participant, or on accessories worn by the participant. For example, an inside-out tracking system that combines motion tracking, area learning, and depth perception such as Google Inc.'s Project Tango® technology may be used for fitness system 10.

Headset 50 preferably is customized for each participant of fitness system 10. Headset 50 can be a virtual reality headset, an augmented reality headset, a mixed reality headset, or a traditional headset. Throughout this application's description and claims, the term virtual reality headset is used to refer to all types of headsets that incorporate some form of virtual, augmented, or mixed reality features including virtual reality headsets, augmented reality headsets, and mixed reality headsets. In addition to having positional tracking sensors 130 and optional additional feedback sensor 132 attached to it, headset 50 also preferably includes the typical features found on a virtual, augmented, or mixed reality headset so that the participant can enjoy a virtual, augmented, or mixed reality environment while exercising. For example, preferably headset 50 includes a headset display, headset audio components, relevant software stored locally or remotely, control and processing components, and optionally a microphone. Accordingly, the participant may be able to view on a display of headset 50 content that shows the participant exercising, working with a trainer, competing against or working with another participant, playing a game, or the like. Additionally, through the audio components, the participant may be able to hear instruction from a trainer, hear comments from another participant, or hear sound effects from a game he is playing. Interactive content provided through headset 50 is preferably delivered based on the information obtained from the positional tracking system and some or all of the other sensors located among the smart handles and other elements of fitness system 10. Headset 50 may also replace computer system 80 or house some of the components of computer system 80 if desired.

Like the display on headset 50, an optional standalone display 60 may also be useful with fitness system 10 to allow a participant to experience personalized content without having to wear the headset. It also may be useful for providing information to a trainer who may be working with the participant or to other third parties present in fitness system's dedicated training area. In some embodiments of the present invention, display 60 may be located remotely from dedicated training area 20 for use by trainers or other third parties who are not physically present in dedicated training area 20. Display 60 may be an ordinary two-dimensional display or a display capable of delivering three-dimensional content. Display 60 may include input devices, a remote control, or other features commonly associated with displays. Like headset 50, display 60 also may replace computer system 80 or house some of the components of computer system 80 if desired.

Computer system 80 preferably houses together or among connected components, control and processing components such as a processor, memory, and wireless or wired communication components as is well known in the art. Likewise, control and processing components presented herein, such as equipment control and processing components 417 and game controller components 960, may also include a processor and memory, communication components, input and output components, or any other feature of a computer system as is known to those skilled in the art. Computer system 80 can be an independent component within fitness system 10, a combination of components across fitness system 10, or integral with any individual component of fitness system 10. Wireless communications components include near field communication components, the wireless communications components discussed above, and longer range communications components to facilitate communication with the various fitness system 10 elements and to facilitate communication with software and content located remotely or accessible only via the Internet. Software can be stored on the computer system's memory and is preferably executable by the processor to perform many tasks, including, for example to calculate positions of the participant and equipment using information from the positional tracking system 10, to process information obtained from other sensors and input devices, to adjust content that is delivered on display 60 or headset 50, to control the resistance and position of the resistance machines and components, to operate any haptic feedback components, and to provide any other information needed by the participant, his trainer, third parties, or fitness system in general.

In some embodiments of fitness system 10, computer 80 is integrated in whole or part with headset 50 or display 60. In other embodiments both computer 80 and headset 50 and/or display 60 contain all of the components detailed above with respect to computer 80. Regardless of whether the computer 80, headset 50, or display 60 stores and executes software, the following processes and calculations may be included in a single software program, among multiple integrated or cooperative programs, or among multiple independent programs:
Calculate the position of each of the fitness system objects (e.g., headset, accessories, smart handles).
Evaluate signals received from the game controller components and provide game instructions including controlling haptic feedback, adjusting virtual, augmented, or mixed reality content, positioning equipment, and adjusting equipment resistance.
Provide virtual, augmented, or mixed reality content.
Track and evaluate the participant's movements (speed, reps, biomechanical leverage,) and the exercises being performed
Evaluate whether resistance should be increased/decreased based on information received regarding the participant's position or movements or based on the equipment's specifications, position, or movement.
Position equipment and adjust resistance according to the information collected about the participant's movements—in particular in light of the participant's actual strength, form, goals, and fitness history.
Provide information to the participant about posture, efficiency, and best practices in light of information collected about the participant in general or in relation to his movements.
Evaluate scan data from optional volumetric scanners as well as other participant information to determine how participant's body changes over one or more uses of the fitness system and to track weight or fat loss, muscle gain, endurance gain, and increases in agility.
Control fans, lights, smells according to signals in games operated by the participant or according to direct participant instruction.
Receive and process inputs from microphones, switches, buttons, and other input devices.
Connect with other fitness systems and dedicated training areas or with other participants to facilitate multi-player games or team instructions, team exercises, or other ordinary or virtual reality team content.
Log and evaluate fitness system and participant information and evaluating participant's performance in real life.
Provide information related to a software development kit for accommodating additional games and experiences for the fitness system.

Optional additional input devices 90 fitness system 10 include microphones, pressure sensors, scanners, touchscreens, pedals, pull-cords, and any other type of input device that would provide information useful to a fitness or gaming system and fitness or gaming environment. For example, pressure sensors may be positioned in the floor or on the walls to further track aspects of the participant's fitness performance. Likewise, microphones or touchpads may be located at key locations to allow the participant to communicate instructions for the system, to communicate messages to remotely located trainers or therapists, or to record notes about his performance or state of being for review at a later time. Optional volumetric scanners may be associated with fitness system 10 to scan the participant and provide information to the system about body changes.

Optional additional output devices 95 of fitness system 10 include fans, lights, speakers, heaters, air conditioners, displays, air fresheners or purifiers, scent generators, vibration generators, and any other type of output device that would provide useful feedback to a participant or would be useful in controlling the environment of a fitness system. For example, participant may want to hear audible cues about his performance that are broadcast to the dedicated training area. Additionally, the participant may wish to change the temperature or airflow in the dedicated training area by controlling fans, heaters, or air conditioners. Other output devices like vibration generators and scent generators may be useful for providing haptic feedback, as discussed above.

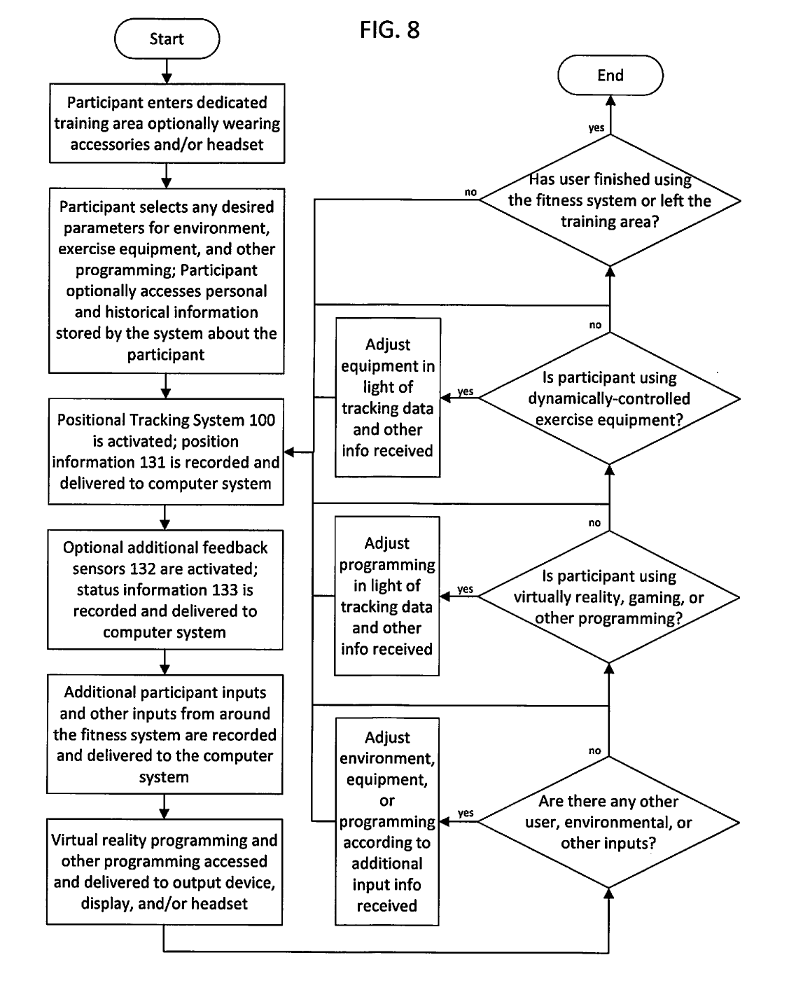

FIG. 8 illustrates a method of use for fitness system 10. In general, to use fitness system 10, a participant, optionally wearing one or more accessories 70 and/or headset 50, enters dedicated training area to access the exercise equipment, optionally selects any desired fitness or gaming programs, any desired fitness or gaming environment parameters, and any whether to participate in virtual reality, augmented reality, mixed reality, or other programming. Additionally, the participant may access any personal and historical data about the participant stored by fitness system 10 or accessible via the Internet. When selected, virtual, augmented, or mixed reality programming or other programming may be delivered either on the display 60 or on headset 50 display. Likewise, the equipment is positioned, calibrated, and initialized according to the selected fitness program, and the environment is created according to the environment parameters selected. The positional tracking system activates to collect position information 131, and the position of the equipment and the participant are tracked, recorded, and evaluated. Additional information such as status information 133 is gathered from additional sensors on the participant or equipment and other additional information is also is gathered through any other or inputs (e.g., pressure sensors in the floor or wall) where appropriate. Based on the position of the equipment and participant and based on any additional sensed or received information, virtual, augmented, or mixed reality content, additional programming, the equipment, and the environment can all be adjusted. Where gaming programming is selected by the participant, the interactive game adjusts according to the tracked positions of the equipment and participant and/or according to instructions input by the participant using game controller components. Where fitness instruction programming or multi-participant programming is selected, the instruction and interaction with other participants adjusts according to the tracked positions of the equipment and participant and/or according to instructions input by the participant using game controller components or other inputs. Where multiple participants wish to connect in separate dedicated training areas or across fitness systems, the systems are connected, for example, over a local area network, wide area network, or over the Internet. Where it is desired to have the fitness equipment dynamically-adjust according to selected or preprogrammed parameters, the equipment position and behavior (e.g., resistance, speed, intensity) adjusts according to the tracked positions of the equipment and participant that are evaluated by the computer system and/or according to instructions input by the participant using game controller components or other inputs. It is believed, that using fitness system 10, a participant who enjoys three 30-minute fitness sessions a week will increase his strength, endurance, and health and will achieve his desired body composition and shape, all while enjoying his fitness sessions. While 30-minute fitness sessions are suggested, fitness system 10 may be used for longer or shorter time periods and may be used more or less frequently depending on the goals or interests of the participant.

While there has been illustrated and described what is at present considered to be the preferred embodiment of the present invention, it will be understood by those skilled in the art that various changes and modifications may be made and equivalents may be substituted for elements thereof without departing from the true scope of the invention disclosed, but that the invention will include all embodiments falling within the scope of the claims.

We claim:

1. A dynamic fitness system for use by a participant comprising:
a. a dedicated training area accessible to the participant;
b. exercise equipment located in the dedicated training area; and
c. a laser-based positional tracking system located in the dedicated training area wherein the positional tracking system comprises at least one positional tracking sensor placed to detect the position of the participant or the equipment while the participant uses the equipment in the dedicated training area.

2. The dynamic fitness system of claim 1 wherein at least one positional tracking sensor is placed to detect the position of the participant while the participant uses the equipment in the dedicated training area.

3. The dynamic fitness system of claim 1 wherein the exercise equipment comprises at least one moving component and wherein at least one positional tracking sensor is attached to the moving component of the exercise equipment.

4. The dynamic fitness system of claim 2 wherein the laser-based positional tracking system further comprises at least one positional tracking base station configured to emit a signal that cooperates with the positional tracking sensors.

5. The dynamic fitness system of claim 4 wherein the base station comprising a plurality of light emitting diodes to provide a synchronization signal at regular intervals, a first laser diode to emit a first constant sweeping signal, and a second laser diode to emit a second constant sweeping signal, wherein the positional tracking sensors are configured to detect both the synchronization signal and the first and second constant sweeping signals.

6. The dynamic fitness system of claim 2 wherein the positional tracking sensors comprise sensor communication components and wherein the fitness system further comprises a computer configured to receive at least position information from the positional tracking sensors and programmed to process the received information, to access and execute content as desired by the participant, and to provide instructions and content to other components of the fitness system as desired.

7. The dynamic fitness system of claim 6 further comprising a display in communication with the computer and configured to receive content from the computer.

8. The dynamic fitness system of claim 6 further comprising a headset in communication with the computer and configured to receive content from the computer.

9. The dynamic fitness system of claim 8 wherein the headset is configured to deliver virtual, augmented, or mixed reality content.

10. The dynamic fitness system of claim 6 wherein the exercise equipment comprises equipment communication components configured to communicate with the computer and equipment control and processing components configured to execute instructions received from the computer.

11. The dynamic fitness system of claim 10 wherein the exercise equipment comprises an electronically controlled cable system.

12. The dynamic fitness system of claim 6 wherein the exercise equipment comprises a smart handle comprising:
a. at least one user input; and
b. game controller communication components configured to communicate received user input with the computer.

13. The dynamic fitness system of claim 12 wherein the smart handle is a moveable component of the exercise equipment and further comprises at least one positional tracking sensor in communication with the game controller communication components, wherein the game controller communication components are further configured to communicate the position information of the smart handle detected by the positional tracking sensor.

14. The dynamic fitness system of claim 13 further comprising a display in communication with the computer and positioned in the dedicated training area such that the participant can see the display.

15. The dynamic fitness system of claim 2 wherein at least one positional tracking sensor is placed on a wearable accessory.

16. The dynamic fitness system of claim 6 further comprising a plurality of feedback sensors in communication with the computer and located in the dedicated training area.

17. A dynamic fitness system for use by a participant comprising:
a. a dedicated training area accessible to the participant;
b. exercise equipment located in the dedicated training area and configured for use by the participant; and
c. a laser-based positional tracking system comprising at least one positional tracking base station configured to emit a signal that cooperates with a first plurality of positional tracking sensors and a second plurality of positional tracking sensors, wherein the first plurality of positional tracking sensors are placed directly or indirectly on the participant and configured to determine and collect participant position information in the dedicated training area and wherein the second plurality of positional tracking sensors are placed on the equipment and configured to determine and collect equipment position information in the dedicated training area.

18. The dynamic fitness system of claim 17 wherein:
a. the first and second plurality of positional tracking sensors each comprise sensor communication components;
b. the fitness system further comprises a computer configured to receive the participant position information and the equipment position information from the first and second pluralities of positional tracking sensors; and
c. the computer system is further programmed to process the received participant and equipment position information, to access and execute content as desired by the participant, and to provide instructions and content to other components of the fitness system as desired.

19. The dynamic fitness system of claim 18 wherein the exercise equipment is in communication with the computer and comprises equipment control and processing components configured to adjust the exercise equipment according to instructions received from the computer.

20. The dynamic fitness system of claim 18 further comprising a display placed in view of the participant, wherein the display is in communication with the computer and configured to receive instructions and content from the computer.
